(19) United States
(12) Patent Application Publication
(10) Pub. No.: US 2024/0037244 A1
(43) Pub. Date: Feb. 1, 2024

(54) METHOD FOR PROVIDING SECURITY POSTURE, FUNCTIONAL UPDATES FOR ENTERPRISE ITDM

(71) Applicant: Dell Products L.P., Round Rock, TX (US)

(72) Inventors: Prasanth Raghavendra K S, Bangalore (IN); Mohit ARORA, Austin, TX (US); Ratan Kumar NAIK, Bangalore (IN)

(73) Assignee: Dell Products L.P., Round Rock, TX (US)

(21) Appl. No.: 17/877,359

(22) Filed: Jul. 29, 2022

(51) Int. Cl. G06F 21/57

(52) U.S. Cl. CPC G06F 21/577; G06F 2221/033

(57) ABSTRACT

A disclosed method for managing enterprise security posture includes maintaining a security system repository (SSR) including information mapping one or more software libraries to vulnerability information indicative of one or more identified vulnerabilities, providing one or more library scanning tools configured to scan the one or more software libraries and provide notifications indicative of one or more new vulnerabilities, generating an SSR catalog indicative of vulnerability information pertaining to the one or more software libraries, and an enhanced plugin module (EPM) is provided wherein the EPM is configured to consume installed application metadata enabling to produce an inventory indicative of updates to deploy.

### TECHNICAL FIELD

The present disclosure relates to information handling systems and, more particularly information technology decision makers (ITDM).

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

During the last two decades, the design and deployment of modern data centers have changed drastically while the emergence of virtualization and cloud technologies have radically altered the software development process. In an effort to cope with market demands and achieve scalability requirements, developers have increasingly integrated or otherwise employed third-party and/or open source applications.

Issues may arise when, for example, such components must be patched for security vulnerabilities. If a particular library is common to multiple applications, each of the applications may be required to replicate the same effort to patch/backport the vulnerability fix. This duplicative effort may negatively impact the overall time to fix (TTF), which can have a consequential impact on the entity's profile.

On average, every product has at least one or two third party components integrated into the solution and, in at least some instances, many of these third party components are common across numerous products. Examples of widely adopted libraries include, as non-limiting examples, Log4j, DBUtils, and OpenSSL.

An increasing number of reported third party vulnerabilities is driving shorter vulnerability response times as part of security policy required by large customers. For example, anecdotal evidence suggests that businesses such as large banks may now have a response requirement of three days for a critical risk vulnerability and 30 days for a high risk vulnerability, while government agencies may have response requirements that are only slightly less stringent. Nevertheless, enterprise customers may lack a mechanism for associating security policies with software updates being picked for each successive refresh cycle. More generally, information technology decision makers (ITDMs) may lack manageable and secure methods for discovering vulnerability updates in a timely manner. Simultaneously, ITDMs are demanding details regarding updates available for a particular SWB or segment. Data suggests that many vulnerability attacks succeed long after the underlying vulnerability is disclosed. A recent study reported that 86% of all organizations had experienced at least one successful attack and that the estimated global damage attributable to ransomware was roughly $20 Billion. Astonishingly, however, another study suggested that roughly 75% of all successful attacks in 2020 exploited a vulnerability that was at least 2 years old, i.e., had been publically disclosed 2 or more years prior to the applicable attack.

### SUMMARY

In accordance with teachings disclosed herein, common problems associated with maintaining vulnerability updates are addressed by systems and methods for providing security posture and functional updates for enterprise ITDMs as disclosed herein. For purposes of this disclosure, “security posture” encompasses the security status of an enterprise's networks, information, and systems based on information security resources (e.g., people, hardware, software, policies) and capabilities in place to manage the defense of the enterprise and to react as the situation changes.

Systems disclosed herein may include a System Security Repository (SSR) and Enhanced Plugin for Configuration Manager/Update Tools (EPM). The SSR may connect to existing third party library scanning tools and OEM-developed tools to collate security posture. A publication-subscription system captures notifications from the scanning tools when a new vulnerability is confirmed/reported. An update system pulls updated libraries into the SSR once patches are made available.

An SSR catalog contains corresponding versions for the list of libraries and the applications from the above mentioned database, the Common Vulnerability Scoring System (CVSS) score, and the Common Vulnerabilities and Enumeration (CVE) details for the resolved vulnerabilities.

After a vulnerability is addressed, the catalog is updated with the newer version of the library and the fix will be deployed to all products that leverage the vulnerable library using a suitable update service, e.g., Bradbury Update Service.

The catalog may be integrated with an OEM Cloud Client Repository Manager (CCRM) to notify the ITDMs and enable them to deploy security fixes to their environment faster. An IT Admin can view the CVSS score, CVE details and the applications that need to be fixed through a CCRM Portal integrated with an OEM Tech Direct service.

The catalog may carry the mapping of the applications to the third party libraries used by them. The same catalog may be extended to the OEM third party catalog containing the OEM's update packages for Microsoft End Point Configuration Manager (MEMCM)

The EPM consumes an inventory for installed application metadata including, but not limited to: the current security posture of the available updates, a heat map system level and fleet level, and upcoming fixes and functional enhancement timelines.

Based on the inventory supplied by the EPM, the update solution, e.g., Dell Command Update, identifies the updates to deploy/patch and provide enhanced viewpoint for an ITDM.

An OEM's update solutions may display all vulnerability updates available on the system, including CVE scores along with timelines for upcoming fixes. The customer may receive detailed and precise information regarding the functional changes related to the software updates. The vulnerability response times may beneficially decrease, which is desirable for any organization that uses the update tools to get the regular updates. The strategic value to the OEM is high, particularly when the OEM offers multiple update tools to consumer-disclosed features for providing the security posture and functional changes to ITDM. Disclosed systems can be extended to any update solutions and may incorporate additional intelligence including, without limitation, visualization intelligence such as a heat map, a dashboard, or the like.

Disclosed systems and methods beneficially implement and support an ability to alert customers regarding vulnerable packages installed on their machines and to indicate corresponding fix timelines. Disclosed systems and methods also support an ability to plan refresh cycles containing safe updates, thereby increasing the security posture of enterprise customers. Disclosed systems still further provide granular details of the functional changes to plan refresh cycles more effectively.

A disclosed method for managing enterprise security posture includes maintaining an SSR including information mapping one or more software libraries to vulnerability information indicative of one or more identified vulnerabilities, providing one or more library scanning tools configured to scan the one or more software libraries and provide notifications indicative of one or more new vulnerabilities, generating an SSR catalog indicative of vulnerability information pertaining to the one or more software libraries, and providing an enhanced plugin module (EPM) wherein the EPM is configured to consume installed application metadata enabling to produce an inventory indicative of updates to deploy.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a system for managing enterprise security posture in accordance with disclosed teachings;

FIG. 2 illustrates a method for managing enterprise security posture in accordance with disclosed teachings; and

FIG. 3 illustrates an information handling system suitable for use in conjunction with disclosed teachings.

### DETAILED DESCRIPTION

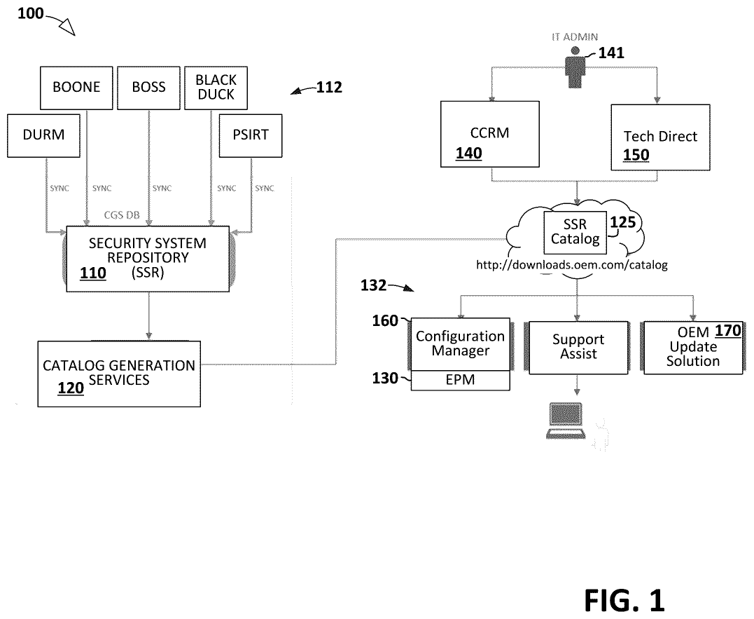

Exemplary embodiments and their advantages are best understood by reference to FIGS. 1-3, wherein like numbers are used to indicate like and corresponding parts unless expressly indicated otherwise.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”), microcontroller, or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

Additionally, an information handling system may include firmware for controlling and/or communicating with, for example, hard drives, network circuitry, memory devices, I/O devices, and other peripheral devices. For example, the hypervisor and/or other components may comprise firmware. As used in this disclosure, firmware includes software embedded in an information handling system component used to perform predefined tasks. Firmware is commonly stored in non-volatile memory, or memory that does not lose stored data upon the loss of power. In certain embodiments, firmware associated with an information handling system component is stored in non-volatile memory that is accessible to one or more information handling system components. In the same or alternative embodiments, firmware associated with an information handling system component is stored in non-volatile memory that is dedicated to and comprises part of that component.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically. Thus, for example, “device 12-1” refers to an instance of a device class, which may be referred to collectively as “devices 12” and any one of which may be referred to generically as “a device 12”.

As used herein, when two or more elements are referred to as “coupled” to one another, such term indicates that such two or more elements are in electronic communication, mechanical communication, including thermal and fluidic communication, thermal, communication or mechanical communication, as applicable, whether connected indirectly or directly, with or without intervening elements. Referring now to FIG. 1, a system 100 in accordance with disclosed teachings includes a System Security Repository (SSR) 110 and an Enhanced Plugin Module (EPM) 130 for Configuration Manager/Update Tools 132. The SSR 110 illustrated in FIG. 1 may include a cumulative database mapping various software libraries to vulnerabilities including, without limitation, vulnerabilities included in the CVE List, and/or any other suitable catalog or listing of known vulnerabilities.

The illustrated SSR 110 is connected to various exemplary library scanning tools 112, including, in at least some embodiments, OEM-developed scanning tools such as DURM, BOONE, Blackduck, PSIRT, etc. to collate security posture information. SSR 110 may be implemented as a publication-subscription system that captures notifications from scanning tools 112 whenever a new vulnerability is confirmed/reported. Updated libraries may be pulled into SSR 110 whenever patches are made available.

The system 100 of FIG. 1 includes catalog generation services 120 for generating an SSR catalog 125 from input provided by SSR 110. The SSR catalog 125 may include entries indicating version information, a CVSS score, and CVE details for some or all of the libraries and applications in SSR 110.

After an identified vulnerability is resolved or otherwise addressed, SSR catalog 125 may be updated with the newer version of the library and the applicable fix may be deployed to all products that leverage the vulnerable library using a suitable update service from an OEM or elsewhere, e.g., Bradbury Update Service.

SSR catalog 125 may be integrated with an OEM Cloud Client Repository Manager (CCRM) 140 to notify the ITDMs and enable them to deploy security fixes to their environment faster. An IT Admin 141 can view the CVSS score, CVE details and the applications that needs to be fixed through a CCRM Portal (not depicted in FIG. 1) integrated with an OEM Tech Direct service 150.

Catalog 125 may include information mapping applications to third party libraries used by them. Catalog 125 may also be extended to an OEM third party catalog containing the OEM's update packages for a Configuration Manager resource, e.g., Microsoft End Point Configuration Manager (MEMCM) 160.

The EPM 130 may generate and/or maintain an inventory for installed application metadata including, but not limited to: the current security posture of available updates, heat maps at a system level, fleet level, etc., and upcoming fixes and functional enhancement timelines.

Based on the inventory supplied by EPM 130, an OEM update solution 170, e.g., Dell Command Update, identifies the updates to deploy/patch, providing ITDMs with an enhanced viewpoint.

An OEM's update solutions may display all vulnerability updates available on the system, including CVE scores along with timelines for upcoming fixes. The customer may receive detailed and precise information regarding the functional changes related to the software updates. The vulnerability response times may beneficially decrease, which is desirable for any organization that uses the update tools to receive and process regular updates. The strategic value to the OEM is high, particularly when the OEM offers multiple update tools to consume disclosed features for providing the security posture and functional changes to the ITDM. Disclosed systems can be extended to any update solutions and may incorporate additional intelligence including, without limitation, visualization intelligence such as a heat map, a dashboard, or the like.

Disclosed systems and methods beneficially implement and support an ability to alert customers regarding vulnerable packages installed on their machines and to indicate corresponding fix timelines. Disclosed systems and methods also support an ability to plan refresh cycles containing safe updates, thereby increasing the security posture of enterprise customers. Disclosed systems may still further provide granular details of the functional changes to plan refresh cycles more effectively.

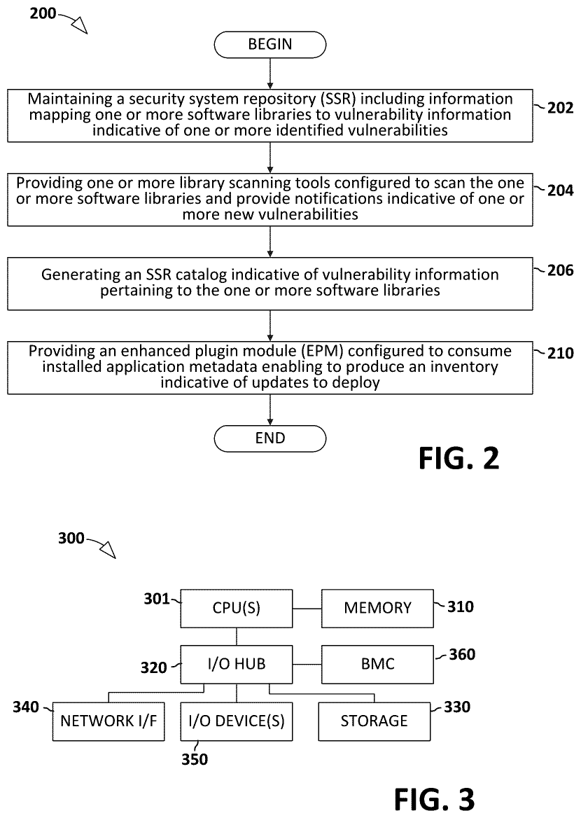

Referring now to FIG. 2, a flow diagram illustrates a method 200 for managing enterprise security posture and functional updates. The method 200 illustrated in FIG. 2 includes maintaining (step 202) an SSR including information mapping one or more software libraries to vulnerability information indicative of one or more identified vulnerabilities. Method 200 further includes providing (step 204) one or more library scanning tools configured to scan the one or more software libraries and provide notifications indicative of one or more new vulnerabilities. As depicted in FIG. 2, an SSR catalog indicative of vulnerability information pertaining to the one or more software libraries is generated (step 206) and an enhanced plugin module (EPM) is provided (step 210) wherein the EPM is configured to consume installed application metadata enabling to produce an inventory indicative of updates to deploy.

Referring now to FIG. 3, any one or more of the elements illustrated in FIG. 1 through FIG. 2 may be implemented as or within an information handling system exemplified by the information handling system 300 illustrated in FIG. 3. The illustrated information handling system includes one or more general purpose processors or central processing units (CPUs) 301 communicatively coupled to a memory resource 310 and to an input/output hub 320 to which various I/O resources and/or components are communicatively coupled. The I/O resources explicitly depicted in FIG. 3 include a network interface 340, commonly referred to as a NIC (network interface card), storage resources 330, and additional I/O devices, components, or resources 350 including as non-limiting examples, keyboards, mice, displays, printers, speakers, microphones, etc. The illustrated information handling system 300 includes a baseboard management controller (BMC) 360 providing, among other features and services, an out-of-band management resource which may be coupled to a management server (not depicted). In at least some embodiments, BMC 360 may manage information handling system 300 even when information handling system 300 is powered off or powered to a standby state. BMC 360 may include a processor, memory, an out-of-band network interface separate from and physically isolated from an in-band network interface of information handling system 300, and/or other embedded information handling resources. In certain embodiments, BMC 360 may include or may be an integral part of a remote access controller (e.g., a Dell Remote Access Controller or Integrated Dell Remote Access Controller) or a chassis management controller.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A method comprising:
maintaining a security system repository (SSR) including information mapping one or more software libraries to vulnerability information indicative of one or more identified vulnerabilities;
providing one or more library scanning tools configured to scan the one or more software libraries and provide notifications indicative of one or more new vulnerabilities;
generating an SSR catalog indicative of vulnerability information pertaining to the one or more software libraries; and
providing an enhanced plugin module (EPM) configured to consume installed application metadata enabling to produce an inventory indicative of updates to deploy.

2. The method of claim 1, wherein the vulnerability information included in entries of the SSR catalog comprise one or more of: version information, a common vulnerability scoring system (CVSS) score, and Common Vulnerabilities and Enumeration (CVE) details.

3. The method of claim 1, further comprising updating the SSR catalog responsive to detecting resolution of an identified vulnerability.

4. The method of claim 3, further comprising, deploying a fix associated with the resolution to applications that leverage the vulnerable library.

5. The method of claim 1, wherein the SSR catalog includes information mapping applications to libraries used by them.

6. The method of claim 1, wherein the installed application metadata includes one or more of: a current security posture of available updates, system level heat maps, fleet level heat maps, and upcoming fixes and functional enhancement timelines.

7. The method of claim 1, further comprising:
providing information technology decision makers (ITDMs) with the identifying information.

8. An information handling system, comprising:
a central processing unit (CPU);
a computer readable memory including processor executable program instructions that, when executed by the CPU, cause the information handling system to perform operations comprising:
maintaining a security system repository (SSR) including information mapping one or more software libraries to vulnerability information indicative of one or more identified vulnerabilities;
providing one or more library scanning tools configured to scan the one or more software libraries and provide notifications indicative of one or more new vulnerabilities;
generating an SSR catalog indicative of vulnerability information pertaining to the one or more software libraries; and
providing an enhanced plugin module (EPM) configured to consume installed application metadata enabling to produce an inventory indicative of updates to deploy.

9. The information handling system of claim 8, wherein the vulnerability information included in entries of the SSR catalog comprise one or more of: version information, a common vulnerability scoring system (CVSS) score, and Common Vulnerabilities and Enumeration (CVE) details.

10. The information handling system of claim 8, further comprising updating the SSR catalog responsive to detecting resolution of an identified vulnerability.

11. The information handling system of claim 10, further comprising, deploying a fix associated with the resolution to applications that leverage the vulnerable library.

12. The information handling system of claim 8, wherein the SSR catalog includes information mapping applications to libraries used by them.

13. The information handling system of claim 8, wherein the installed application metadata includes one or more of: a current security posture of available updates, system level heat maps, fleet level heat maps, and upcoming fixes and functional enhancement timelines.

14. The information handling system of claim 8, further comprising:
providing information technology decision makers (ITDMs) with the identifying information.
